(19) United States
(12) Patent Application Publication
(10) Pub. No.: US 2024/0052142 A1
(43) Pub. Date: Feb. 15, 2024

(54) RUBBER COMPOSITION

(71) Applicant: COMPAGNIE GENERALE DES ETABLISSEMENTS MICHELIN, Clermont-Ferrand (FR)

(72) Inventors: JOSE-CARLOS ARAUJO DA SILVA, Clermont-Ferrand (FR); AURORE CROCHET, Clermont-Ferrand (FR)

(21) Appl. No.: 18/268,816

(22) PCT Filed: Nov. 29, 2021
(86) PCT No.: PCT/FR2021/052126

§ 371 Date: Jun. 21, 2023

(30) Foreign Application Priority Data
Dec. 23, 2020 (FR) 2014026

(51) Int. Cl. C08L 7/00; B60C 1/00

(52) U.S. Cl. CPC C08L 7/00; B60C 1/0025; C08L 2205/03

(57) ABSTRACT

The present invention relates to A rubber composition is based on at least one elastomer matrix comprising from 45 to 80 phr of at least one polyisoprene and from 20 to 55 phr of at least one highly saturated diene elastomer, a tall oil ester plasticizer, carbon black, and a crosslinking system; the highly saturated diene elastomer is a copolymer of ethylene and 1,3-diene.

The field of the present invention is that of rubber compositions reinforced with carbon black and comprising a highly saturated diene elastomer, the rubber compositions being particularly intended for use in a tyre, more particularly in a tyre sidewall.

A tyre usually includes two beads intended to come into contact with a rim, a crown composed of at least one crown reinforcement and a tread, two sidewalls, the tyre being reinforced by a carcass reinforcement anchored in the two beads. A sidewall is an elastomeric layer positioned outside the carcass reinforcement relative to the internal cavity of the tyre, between the crown and the bead, so as to totally or partially cover the region of the carcass reinforcement extending from the crown to the bead.

In conventional tyre manufacture, the various components making up the crown, carcass reinforcement, beads and sidewalls are assembled to form a tyre casing. The assembly step is followed by a step of shaping the casing to give the assembly a toroidal shape before the press curing step.

Tyres, and notably the sidewalls, are subjected to numerous mechanical stresses which are repeated cyclically during rolling. These stresses, in the form of bending and compressive stresses, test the endurance of the tyre and contribute to reducing its lifetime. One way to improve the endurance of the tyre lies in increasing the fatigue resistance of the rubber compositions which constitute the tyre. For example, the use of silica with a low surface area typically less than 125 m²/g, even much less than 100 m²/g, in a rubber composition is described respectively in patents EP 722 977 B1 and EP 547 344 B1 as being favourable to fatigue resistance.

Moreover, tyre sidewalls are also exposed to the action of ozone. The deformation cycles combined with the action of ozone may cause cracks or fissures to appear in the sidewall, preventing the tyre from being used independently of tread wear. Consequently, rubber compositions are sought which are highly cohesive, for example to make up tyre sidewalls by virtue of their ability to undergo large deformations without breaking.

To minimize the action of ozone on rubber compositions, it is known practice to use copolymers with reduced oxidation sensitivity, for instance highly saturated diene elastomers, elastomers comprising ethylene units in a molar content of greater than 50 mol % of the monomer units of the elastomer. Mention may be made, for example, of copolymers of ethylene and of 1,3-diene which contain more than 50 mol % of ethylene, in particular copolymers of ethylene and of 1,3-butadiene. The use of such copolymers of ethylene and of 1,3-butadiene in a tyre tread is described, for example, in WO 2014/114607 A1 and has the effect of giving the tyre good rolling resistance and wear resistance properties. The use of copolymers of ethylene and of 1,3-diene in a sidewall composition is also described, for example, in EP 2 682 423 A1 to increase the resistance to the action of ozone.

In parallel, the use of tall oil ester plasticizer is described in documents JP2008201933, JP2008201944 and JP2008201945 in various elastomer matrices which do not comprise a highly saturated diene elastomer, with effects which are also varied and depend on the elastomer matrices in which this type of plasticizer is used.

In the area discussed above of tyres comprising a highly saturated diene elastomer, there remains a need to further improve the balance between endurance, deformability and hysteresis performance of rubber compositions, notably for use in tyre sidewalls.

In pursuing its research, the Applicant has discovered that the use of a specific plasticizer in a rubber composition comprising a highly saturated copolymer based on ethylene units and diene units makes it possible to improve the balance between the endurance, deformability and hysteresis performance in this composition.

Thus, a first subject of the invention is a rubber composition based on at least an elastomer matrix comprising from 45 to 80 phr of at least one polyisoprene and from 20 to 55 phr of at least one highly saturated diene elastomer; a tall oil ester plasticizer, carbon black, and a crosslinking system; in which the highly saturated diene elastomer is a copolymer of ethylene and 1,3-diene.

Another subject of the composition is a pneumatic or non-pneumatic tyre casing comprising a composition according to the invention, preferably in at least one sidewall of the pneumatic or non-pneumatic tyre casing.

### I—DEFINITIONS

The expression “composition based on” should be understood as meaning a composition including the mixture and/or the product of the in situ reaction of the various constituents used, some of these constituents being able to react and/or being intended to react with each other, at least partially, during the various phases of manufacture of the composition; it thus being possible for the composition to be in the completely or partially crosslinked state or in the non-crosslinked state.

For the purposes of the present invention, the expression “part by weight per hundred parts by weight of elastomer” (or phr) should be understood as meaning the part by mass per hundred parts by mass of elastomer.

In the present text, unless expressly indicated otherwise, all the percentages (%) indicated are mass percentages (%).

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is denoted by the expression “from a to b”, the interval represented by the expression “between a and b” is also and preferentially denoted.

In the present application, the expression “all of the monomer units of the elastomer” or “the total amount of the monomer units of the elastomer” means all the constituent repeating units of the elastomer which result from the insertion of the monomers into the elastomer chain by polymerization. Unless otherwise indicated, the contents of a monomer unit or repeating unit in the highly saturated diene elastomer are given as molar percentages calculated on the basis of all of the monomer units of the elastomer.

When reference is made to a “predominant” compound, this is understood to mean, for the purposes of the present invention, that this compound is predominant among the compounds of the same type in the composition, that is to say that it is the one which represents the greatest amount by mass among the compounds of the same type. Thus, for example, a predominant elastomer is the elastomer representing the greatest mass relative to the total mass of the elastomers in the composition. In the same way, a “predominant” filler is that representing the greatest mass among the fillers of the composition. By way of example, in a system comprising only one elastomer, the latter is predominant for the purposes of the present invention, and in a system comprising two elastomers, the predominant elastomer represents more than half of the mass of the elastomers. In contrast, a “minor” compound is a compound which does not represent the greatest fraction by mass among the compounds of the same type. Preferably, the term “predominant” means present to more than 50%, preferably more than 60%, 70%, 80%, 90%, and more preferentially the “predominant” compound represents 100%.

The compounds mentioned in the description may be of fossil origin or may be biobased. In the latter case, they may be partially or completely derived from biomass or may be obtained from renewable starting materials derived from biomass. Similarly, the compounds mentioned may also be derived from the recycling of already-used materials, i.e. they may be partly or totally derived from a recycling process, or obtained from raw materials which are themselves derived from a recycling process. Polymers, plasticizers, fillers, etc. are notably concerned.

Unless otherwise indicated, the glass transition temperature “Tg” values described herein are measured in a known manner by DSC (Differential Scanning Calorimetry) according to the standard ASTM D3418 (1999).

### II—DESCRIPTION OF THE INVENTION

### II-1 Elastomer Matrix

The term “elastomer matrix” means all the elastomers of the composition.

According to the invention, the elastomer matrix comprises from 45 to 80 phr of at least one polyisoprene and from 20 to 55 phr of at least one highly saturated diene elastomer, the latter being a copolymer of ethylene and 1,3-diene (referred to hereinbelow as “the copolymer”).

The term “copolymer containing ethylene units and 1,3-diene units” means any copolymer comprising, within its structure, at least ethylene units and 1,3-diene units. The copolymer may thus comprise monomer units other than ethylene units and 1,3-diene units. For example, the copolymer may also comprise α-olefin units, in particular α-olefin units containing from 3 to 18 carbon atoms, advantageously containing 3 to 6 carbon atoms. For example, the α-olefin units can be chosen from the group consisting of propylene, butene, pentene, hexene or mixtures thereof.

In a known manner, the term “ethylene unit” refers to the —(CH₂—CH₂)— unit resulting from the insertion of ethylene into the elastomer chain.

The term “1,3-diene unit” means a monomer unit derived from the insertion of a monomer unit resulting from the polymerization of a 1,3-diene monomer. In particular, the 1,3-diene units of the copolymer may be 1,3-diene units containing 4 to 12 carbon atoms, for example 1,3-butadiene or 2-methyl-1,3-butadiene units. More preferably, the 1,3-diene units are predominantly or even preferentially exclusively 1,3-butadiene units.

In the copolymer, the ethylene units advantageously represent between 50 mol % and 95 mol % of the monomer units of the copolymer, i.e. between 50 mol % and 95 mol % of the monomer units of the copolymer. Advantageously, the ethylene units in the copolymer represent more than 60 mol %, preferably more than 70 mol % of the monomer units of the copolymer. Also advantageously, in the copolymer, the ethylene units represent not more than 90 mol %, preferably not more than 85 mol %, of the monomer units of the copolymer.

Advantageously, the copolymer (that is to say, as a reminder, the at least one copolymer containing ethylene units and diene units) is a copolymer of ethylene and 1,3-diene (preferably 1,3-butadiene), that is to say, according to the invention, a copolymer consisting exclusively of ethylene units and 1,3-diene (preferably 1,3-butadiene) units, more preferentially a random copolymer of ethylene and 1,3-diene (preferably 1,3-butadiene).

When the copolymer is a copolymer of ethylene and a 1,3-diene, it advantageously contains units of formula (I) [Chem 1] and/or (II) [Chem 2]. The presence of a saturated 6-membered ring unit, 1,2-cyclohexanediyl, of formula (I) as a monomer unit in the copolymer may result from a series of very specific insertions of ethylene and of 1,3-butadiene into the polymer chain during its growth.

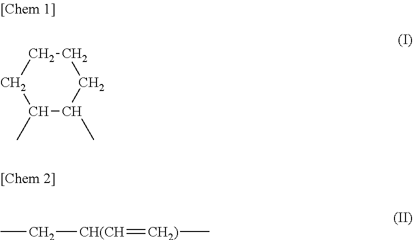

For example, the copolymer of ethylene and a 1,3-diene may be free of units of formula (I). In this case, it preferably contains units of formula (II).

When the copolymer of ethylene and a 1,3-diene comprises units of formula (I) or units of formula (II), the molar percentages of the units of formula (I) and of the units of formula (II) in the highly saturated diene elastomer, o and p respectively, preferably satisfy the following equation (eq. 1) [Math 1], more preferentially the equation (eq. 2) [Math 2], and more preferentially the equation (eq. 3) [Math 3], o and p being calculated on the basis of all of the monomer units of the highly saturated diene elastomer.

[Math 1]

o<o+p≤35 (eq. 1)

[Math 2]

0<o+p≤25 (eq. 2)

[Math 3]

0<o+p<20 (eq. 3)

According to the invention, the copolymer, preferably the copolymer of ethylene and a 1,3-diene (preferably 1,3-butadiene), is a random copolymer.

Advantageously, the number-average mass (Mn) of the copolymer, preferably of the copolymer of ethylene and a 1,3-diene (preferably of 1,3-butadiene), is in a range from 100 000 to 300 000 g/mol, preferably from 150 000 to 250 000 g/mol.

The Mn of the copolymer is determined, in a known manner, by size exclusion chromatography (SEC) as described below:

The SEC (Size Exclusion Chromatography) technique makes it possible to separate macromolecules in solution according to their size through columns filled with a porous gel. The macromolecules are separated according to their hydrodynamic volume, the bulkiest being eluted first. Without being an absolute method, SEC makes it possible to comprehend the distribution of the molar masses of a polymer. The various number-average molar masses (Mn) and weight-average molar masses (Mw) may be determined from commercial standards and the polydispersity index (PDI=Mw/Mn) may be calculated via a “Moore” calibration. There is no specific treatment of the polymer sample before analysis. The latter is simply dissolved in the elution solvent at a concentration of approximately 1 g·l⁻¹. The solution is then filtered through a filter with a porosity of 0.45 μm before injection. The equipment used is a Waters Acquity or Waters Alliance chromatographic chain. The elution solvent is tetrahydrofuran with 250 ppm of BHT (butylated hydroxytoluene) as antioxidant, the flow rate is 1 mL·min⁻¹, the column temperature is 35° C. and the analysis time is 40 minutes. The columns used were a set of three Agilent columns under the trade name InfinityLab PolyPore. The volume of the sample solution injected is 100 μl. The detector is a Waters 2410 or Acquity differential refractometer and the software for processing the chromatographic data is the Waters Empower system. The calculated average molar masses are relative to a calibration curve produced from polystyrene standards.

The copolymer may be obtained according to various synthetic methods known to those skilled in the art, notably as a function of the targeted microstructure of the highly saturated diene elastomer. Generally, it may be prepared by copolymerization at least of a diene, preferably a 1,3-diene, more preferably 1,3-butadiene, and of ethylene and according to known synthetic methods, in particular in the presence of a catalytic system comprising a metallocene complex. Mention may be made in this respect of catalytic systems based on metallocene complexes, which catalytic systems are described in EP 1 092 731, WO 2004/035639, WO 2007/054223 and WO 2007/054224 in the name of the Applicant. The copolymer, including the case when it is random, may also be prepared via a process using a catalytic system of preformed type such as those described in WO 2017/093654 A1, WO 2018/020122 A1 and WO 2018/020123 A1.

The copolymer may consist of a mixture of copolymers containing ethylene units and diene units which differ from each other in their microstructures and/or macrostructures.

As indicated above, the elastomeric matrix of the composition according to the invention also contains a polyisoprene. The polyisoprene may be an elastomer of any microstructure.

Advantageously, the polyisoprene, preferably having a mass content of 1,4-cis bonds of at least 90% of the mass of the polyisoprene, is a natural rubber, a synthetic polyisoprene or a mixture thereof. More preferably, the polyisoprene, preferably having a mass content of cis-1,4-bonds of at least 90% of the mass of the polyisoprene, is a natural rubber.

The content of the copolymer, preferably the copolymer of ethylene and 1,3-diene (preferably 1,3-butadiene), in the composition may be in a range from 20 to 50 phr, preferably in a range from 20 to less than 45 phr, more preferably in a range from 20 to 40 phr.

Moreover, the content of polyisoprene, preferably natural rubber, in the composition may be in a range from 50 to 80 phr, preferably in a range from more than 55 to 80 phr, more preferably in a range from 60 to 80 phr.

According to the invention, the elastomer matrix may comprise at least one other elastomer, which is not a polyisoprene or a copolymer containing ethylene units and diene units, but this is not necessary. Thus, preferentially, the at least one polyisoprene and at least one copolymer containing ethylene units and diene units are the only elastomers in the composition, i.e. they represent 100% by mass of the elastomer matrix.

When the elastomer matrix comprises at least one other elastomer, which is not a polyisoprene or a copolymer containing ethylene units and diene units, the at least one other elastomer may represent less than 50%, preferably less than 40%, preferably less than 30%, preferably less than 20%, preferably less than 10%, by mass of the elastomer matrix. The other elastomer may be any diene elastomer well known to those skilled in the art which is not a polyisoprene or a copolymer containing ethylene units and diene units.

### II-2 Specific Plasticizer

According to the invention, the rubber composition is based on at least one tall oil ester plasticizer (also known as “tallate”).

Preferably, for the purposes of the invention, the tall oil ester plasticizer is present in the composition in a content ranging from 5 to 50 phr, preferably from 7 to 40 phr and more preferentially from 8 to 30 phr. Very preferentially, the content of the tall oil ester plasticizer is in the range from 10 to 25 phr.

Preferably, the tall oil ester plasticizer is a compound of formula Tl(OR)3 in which R is a linear or branched alkyl and Tl represents tall oil (or tallate).

Preferably, R is an alkyl comprising from 4 to 20 carbon atoms, preferably from 6 to 12 carbon atoms and more preferentially from 6 to 10 carbon atoms.

Preferably, R is a branched alkyl, and very preferentially, R is an isooctyl radical.

Very preferentially, the tall oil ester plasticizer is the compound isooctyl tallate, [Chem 3] below.

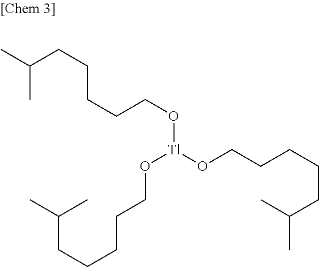

Isooctyl tallate, CAS number 68333-78-8, has a glass transition temperature of −110° C. and is sold, for example, under the name Plasthall 100 by the company Hallstar.

In addition, the composition according to the invention advantageously does not comprise any plasticizer other than the specific plasticizer above, or contains less than phr thereof, preferably less than 10 phr thereof, preferably less than 5 phr thereof.

### II-3 Reinforcing Filler

Another essential feature of the rubber composition according to the invention is that it comprises a reinforcing filler comprising carbon black.

The rubber composition may comprise any other type of “reinforcing” filler known for its abilities to reinforce a rubber composition that may be used for the manufacture of tyres, for example an organic filler other than carbon black, a reinforcing inorganic filler, such as silica, with which a coupling agent is combined in a known manner. Such a reinforcing filler typically consists of nanoparticles, the (mass-)average size of which is less than a micrometre, generally less than 500 nm, usually between 20 and 200 nm, in particular and more preferentially between 20 and 150 nm.

All carbon blacks, in particular the blacks conventionally used in tyres or their treads, are suitable as carbon blacks. Among the latter, mention will be made more particularly of the reinforcing carbon blacks of the 100, 200 and 300 series, or the blacks of the 500, 600 or 700 series (ASTM D-1765-2017 grades), for instance the N115, N134, N234, N326, N330, N339, N347, N375, N550, N683 and N772 blacks. These carbon blacks may be used in isolated form, as commercially available, or in any other form, for example as support for some of the rubber engineering additives used. The carbon blacks might, for example, be already incorporated into the diene elastomer, notably an isoprene elastomer, in the form of a masterbatch (see, for example, patent applications WO 97/36724-A2 and WO 99/16600-A1).

Advantageously, the carbon black has a BET specific surface area in a range from 30 to 100 m²/g, preferably from 33 to 70 m²/g, more preferably from 35 to 50 m²/g. The BET specific surface area can be measured according to Standard ASTM D6556-09 [multipoint method (5 points)—gas: nitrogen—relative pressure range P/P0: 0.05 to 0.30].

Advantageously, the reinforcing filler predominantly, preferably exclusively, comprises carbon black. In particular, the reinforcing filler preferably consists of at least 80% by weight, preferably at least 90% by weight, of carbon black. Particularly preferably, the reinforcing filler comprises exclusively, i.e. 100% by weight, carbon black.

The carbon black content, in the composition according to the invention, is preferentially in a range from 15 to 65 phr, preferably from 20 to 45 phr. The carbon black may be a mixture of different carbon blacks, in which case the carbon black contents relate to all the carbon blacks.

### II-4 Crosslinking System

The crosslinking system may be any type of system known to those skilled in the art in the field of rubber compositions for tyres. It may in particular be based on sulfur, and/or on peroxide and/or on bismaleimides.

Preferentially, the crosslinking system is based on sulfur; it is then called a vulcanization system. The sulfur can be provided in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

The sulfur is used in a preferential content of between 0.2 phr and 10 phr, more preferentially between 0.3 and 5 phr. The primary vulcanization accelerator is used in a preferential content of between 0.5 and 10 phr, more preferentially of between 0.5 and 5 phr.

Use may be made, as accelerator, of any compound that is capable of acting as an accelerator for the vulcanization of diene elastomers in the presence of sulfur, notably accelerators of the thiazole type, and also derivatives thereof, or accelerators of sulfenamide, thiuram, dithiocarbamate, dithiophosphate, thiourea and xanthate type. As examples of such accelerators, mention may notably be made of the following compounds: 2-mercaptobenzothiazyl disulfide (abbreviated as “MBTS”), N-cyclohexyl-2-benzothiazolesulfenamide (“CBS”), N,N-dicyclohexyl-2-benzothiazolesulfenamide (“DCBS”), N-(tert-butyl)-2-benzothiazolesulfenamide (“TBBS”), N-(tert-butyl)-2-benzothiazolesulfenimide (“TBSI”), tetrabenzylthiuram disulfide (“TBZTD”), zinc dibenzyldithiocarbamate (“ZBEC”) and mixtures of these compounds.

### II-5 Possible Additives

The rubber compositions according to the invention may optionally also include all or some of the usual additives customarily used in elastomer compositions for tyres, for instance pigments, protective agents such as anti-ozone waxes, chemical anti-ozonants, antioxidants, anti-fatigue agents, reinforcing resins (as described, for example, in patent application WO 02/10269).

Advantageously, the composition according to the invention does not comprise a hydrocarbon-based plasticizing resin.

### II-6 Preparation of the Rubber Compositions

The compositions in accordance with the invention may be manufactured in appropriate mixers using two successive preparation phases that are well known to those skilled in the art:
a first phase of thermomechanical working or kneading (“non-productive” phase), that can be performed in a single thermomechanical step during which all the necessary constituents, notably the elastomeric matrix, the reinforcing filler and the various other optional additives, with the exception of the crosslinking system, are introduced into an appropriate mixer, such as a standard internal mixer (for example of Banbury type). The incorporation of the optional filler into the elastomer may be performed in one or more portions while thermomechanically kneading. In the case where the filler is already incorporated, totally or partly, into the elastomer in the form of a masterbatch, as is described, for example, in patent applications WO 97/36724 or WO 99/16600, it is the masterbatch which is directly kneaded and, where appropriate, the other elastomers or fillers present in the composition which are not in masterbatch form, and also the optional various other additives, with the exception of the crosslinking system, are incorporated. The non-productive phase may be performed at high temperature, up to a maximum temperature of between 110° C. and 200° C., preferably between 130° C. and 185° C., for a period of time generally of between 2 and 10 minutes;
a second phase of mechanical working (“productive” phase), which is performed in an external mixer, such as an open mill, after cooling the mixture obtained during the first non-productive phase down to a lower temperature, typically below 120° C., for example between 40° C. and 100° C. The crosslinking system is then incorporated and the combined mixture is then mixed for a few minutes, for example between 5 and 15 min.

Such phases have been described, for example, in patent applications EP-A-0501227, EP-A-0735088, EP-A-0810258, WO 00/05300 or WO 00/05301.

The final composition thus obtained is then calendered, for example in the form of a sheet or of a slab, notably for laboratory characterization, or else is extruded (or co-extruded with another rubber composition) in the form of a rubber semi-finished product (or profiled element) which can be used, for example, as a tyre sidewall. These products may then be used for the manufacture of tyres, according to the techniques known to those skilled in the art.

The composition may be either in the raw state (before crosslinking or vulcanization) or in the cured state (after crosslinking or vulcanization), or may be a semi-finished product which can be used in a tyre.

The crosslinking (or curing), or, where appropriate, the vulcanization, is performed in a known manner at a temperature generally between 130° C. and 200° C., for a sufficient time which may range, for example, between 5 and 90 min, notably depending on the curing temperature, the crosslinking system adopted and the crosslinking kinetics of the composition under consideration.

### II-7 Tyre

A subject of the present invention is also a tyre comprising a rubber composition according to the invention.

Preferably, the composition according to the invention is present at least in a sidewall of the tyre according to the invention. Advantageously, this composition is present exclusively in the sidewalls of the tyre.

The tyre according to the invention may be intended to equip motor vehicles of passenger vehicle type, SUVs (sport utility vehicles), or two-wheel vehicles (notably motorcycles), or aircraft, or else industrial vehicles chosen from vans, heavy-duty vehicles, i.e. underground trains, buses, heavy road transport vehicles (lorries, tractors, trailers) or off-road vehicles, such as heavy agricultural vehicles or construction vehicles, and the like.

### III. IMPLEMENTATIONAL EXAMPLES OF THE INVENTION

### III.1 Tests and Measurements

Dynamic Properties:

The dynamic properties are measured on a viscosity analyser (Metravib V A4000) according to the standard ASTM D5992-96. The response of a sample of vulcanized composition (cylindrical test specimen with a thickness of 4 mm and with a cross section of 400 mm²), subjected to a simple alternating sinusoidal shear stress, at a frequency of 10 Hz, according to the standard ASTM D 1349-99, at a temperature of 23° C., is recorded. A peak-to-peak strain amplitude sweep is performed from 0.1% to 50% (outward cycle), then from 50% to 0.1% (return cycle). The results used are the measurement, in the return cycle, of the moduli G′ and G″ at 10% strain, at 23° C., respectively representing the stiffness (and therefore the deformability) and the hysteresis of the compositions.

For greater readability, the results are shown in base 100 (percentage), the value 100 being assigned to the control. A result of greater than 100 indicates an improvement in the performance under consideration. For “G′ 10% return to 23° C.”, a result of greater than 100 indicates a decrease in modulus and therefore better deformability, which is an important property for endurance in the case of use in tyre sidewalls. For “G″ 10% return to 23° C.”, a result of greater than 100 indicates a decrease in hysteresis and therefore better rolling resistance performance for use in tyres.

### III.2 Preparation of the Rubber Compositions

The elastomer (EBR) is prepared according to the following procedure:

30 mg of metallocene [{Me2SiFlu2Nd(μ-BH4)2Li(THF)}2, the symbol Flu representing the fluorenyl group of formula C13H8], are introduced into a first Steinie bottle in a glovebox. The co-catalyst, butyloctylmagnesium dissolved beforehand in 300 ml of methylcyclohexane in a second Steinie bottle, is introduced into the first Steinie bottle containing the metallocene in the following proportions: 0.00007 mol/L of metallocene, 0.0004 mol/L of co-catalyst. After contact for 10 minutes at ambient temperature, a catalytic solution is obtained. The catalytic solution is then introduced into the polymerization reactor. The temperature in the reactor is then increased to 80° C. When this temperature is reached, the reaction starts by injection of a gaseous mixture of ethylene and 1,3-butadiene (80/20 mol %) into the reactor. The polymerization reaction proceeds at a pressure of 8 bar. The proportions of metallocene and of co-catalyst are, respectively, 0.00007 mol/L and 0.0004 mol/L. The polymerization reaction is stopped by cooling, degassing of the reactor and addition of ethanol. An antioxidant is added to the polymer solution. The copolymer is recovered by drying in a vacuum oven. In a reactor containing, at 80° C., methylcyclohexane, ethylene and butadiene in proportions of 80/20 mol % ethylene/butadiene, butyloctylmagnesium (BOMAG) is added to neutralize the impurities in the reactor, then the catalytic system is added. At this time, the reaction temperature is regulated at 80° C. and the polymerization reaction starts. The polymerization reaction takes place at a constant pressure of 8 bar. The reactor is fed throughout the polymerization with ethylene and butadiene in proportions of 80/20 mol % (ethylene/butadiene). The polymerization reaction is stopped by cooling, degassing of the reactor and addition of ethanol. An antioxidant is added to the polymer solution. The copolymer is recovered by drying in an oven under vacuum to constant mass.

The catalytic system is a preformed catalytic system. It is prepared in methylcyclohexane from a metallocene, [Me2Si(Flu)2Nd(μ-BH4)2Li(THF)], a co-catalyst, butyloctylmagnesium (BOMAG), and a preformation monomer, 1,3-butadiene, in the following contents: metallocene: 0.00007 mol/L, co-catalyst: 0.00036 mol/L. It is prepared according to a preparation method in accordance with paragraph 11.1 of patent application WO 2017093654 A1.

In the examples which follow, the rubber compositions were produced as described in point II-6 above. In particular, the “non-productive” phase was performed in a 0.4 litre mixer for 6 minutes, at an average paddle speed of 50 rpm, until a maximum drop temperature of 160° C. was reached. The “productive” phase was performed in a cylinder tool at 23° C. for 10 minutes.

The crosslinking of the composition was performed at a temperature of between 130° C. and 200° C., under pressure.

### III.3 Rubber Tests

The examples presented below are intended to compare the performance trade-off between the deformability and hysteresis of two compositions in accordance with the invention (C1 and C2), respectively, with two control compositions (T1 and T2).

Table 1 shows the compositions tested (in phr), and Table 2 shows the results obtained, in base 100.

TABLE 1

| Formulations | T1 | C1 | T2 | C2 |
|---|---|---|---|---|
| NR (1) | 50 | 50 | 60 | 60 |
| EBR (2) | 50 | 50 | 40 | 40 |
| Carbon black (3) | 29 | 29 | 29 | 29 |
| Plasticizer 1 (4) | 20 | — | 20 | — |
| Plasticizer 2 (5) | — | 20 | — | 20 |
| Wax | 1 | 1 | 1 | 1 |
| TMQ (6) | 1 | 1 | 1 | 1 |
| 6PPD (7) | 3 | 3 | 3 | 3 |
| CBS (8) | 0.9 | 0.9 | 0.9 | 0.9 |
| ZnO | 3 | 3 | 3 | 3 |
| Stearic acid | 2 | 2 | 2 | 2 |
| Sulfur | 1.75 | 1.75 | 1.75 | 1.75 |

(1) Natural rubber
(2) EBR Mooney 85, ethylene content: 77%,
(3) Carbon black of N550 grade according to the standard ASTM D-1765, from the company Cabot
(4) Tudalen 1968 liquid paraffin from the company Klaus Dahleke
(5) Plasthall 100 oil from Hallstar
(6) 2,2,4-Trimethyl-1,2-dihydroquinoline, Pilnox TMQ from the company Nocil
(7) N-(1,3-Dimethylbutyl)-N-phenyl-para-phenylenediamine, Santoflex 6-PPD from the company Flexsys
(8) N-Cyclohexyl-2-benzothiazolesulfenamide, Santocure CBS from the company Flexsys

TABLE 2

| | T1 | C1 | T2 | C2 |
|---|---|---|---|---|
| G′ 10% return at 23° C. | 100 | 109 | 100 | 105 |
| G″ 10% return at 23° C. | 100 | 111 | 100 | 104 |

The results presented in Table 2 above show that the compositions according to the invention improve the balance of deformability and hysteresis performance relative to the control compositions.

1.-15. (canceled)

16. A rubber composition based on at least:
an elastomer matrix comprising from 45 to 80 phr of at least one polyisoprene and from to 55 phr of at least one highly saturated diene elastomer;
a tall oil ester plasticizer;
carbon black; and
a crosslinking system,
wherein the at least one highly saturated diene elastomer is a copolymer containing ethylene units and diene units.

17. The rubber composition according to claim 16, wherein the ethylene units in the copolymer represent between 50 mol % and 95 mol % of the monomer units of the copolymer.

18. The rubber composition according to claim 16, wherein the copolymer is a copolymer of ethylene and 1,3-butadiene.

19. The rubber composition according to claim 16, wherein the copolymer is a random copolymer.

20. The rubber composition according to claim 16, wherein a content of the copolymer is in a range from 20 to 50 phr.

21. The rubber composition according to claim 16, wherein the at least one polyisoprene is natural rubber, a synthetic polyisoprene or a mixture thereof.

22. The rubber composition according to claim 16, wherein a content of the at least one polyisoprene is within a range from 50 to 80 phr.

23. The rubber composition according to claim 16, wherein a content of tall oil ester plasticizer is within a range from 5 to 50 phr.

24. The rubber composition according to claim 16, wherein the tall oil ester plasticizer is a compound of formula Tl(OR)₃ in which R is a linear or branched alkyl and Tl represents tall oil.

25. The rubber composition according to claim 24, wherein R is an alkyl comprising from 4 to 20 carbon atoms.

26. The rubber composition according to claim 24, wherein R is a branched alkyl.

27. The rubber composition according to claim 16, wherein the tall oil ester plasticizer is the compound isooctyl tallate.

28. The rubber composition according to claim 16, wherein a total carbon black content is between 15 and 65 phr.

29. A pneumatic or non-pneumatic tire carcass which comprises the rubber composition according to claim 16.

30. The pneumatic or non-pneumatic tire carcass according to claim 29, wherein the rubber composition is present in at least a sidewall.
